(19) United States
(12) Patent Application Publication
(10) Pub. No.: US 2024/0308635 A1
(43) Pub. Date: Sep. 19, 2024

(54) IMPROVEMENTS IN OR RELATING TO AN OUTBOARD PROPULSION SYSTEM

(71) Applicant: CAUDWELL MARINE LIMITED, Eccleshall, Stafford (GB)

(72) Inventor: Scott BREDDA, Leighton Buzzard (GB)

(21) Appl. No.: 18/262,968

(22) PCT Filed: Sep. 23, 2021
(86) PCT No.: PCT/GB2021/052472

§ 371 Date: Jul. 26, 2023

(30) Foreign Application Priority Data
Jan. 27, 2021 (GB) 2101088.9
May 14, 2021 (GB) 2106925.7

(51) Int. Cl. B63H 20/12; B63H 20/26; B63H 25/30; F02B 61/04

(52) U.S. Cl. CPC B63H 20/12; B63H 20/26; B63H 25/30; F02B 61/045

(57) ABSTRACT

An outboard propulsion system comprising a first portion for attachment to a boat, wherein the first portion is fixed about a substantially vertical axis, and a second portion connected to the first portion and configured to rotate about a steering axis, wherein the first portion comprises a sealed housing enclosing a member having a longitudinal axis relative to which it may move and the second portion comprises a gear configured to engage with the member such that movement of the member relative to its longitudinal axis generates rotational movement of the gear about the steering axis, and wherein the sealed housing comprises a sensor configured to determine the position of the member within the sealed housing.

The present invention relates to improvements in or relating to an outboard propulsion system, and more specifically, to the steering arrangement of an outboard propulsion system.

A conventional outboard propulsion system is a self-contained unit that can be fitted on the transom of a boat, the system comprising an engine, transmission and propeller (or jet drive). The entire unit can rotate relative to the transom about a vertical steering axis, to control the direction of thrust from the propeller and thus steer the boat. The entire unit can also be rotated relative to the transom about a transverse, horizontal trim/tilt axis, to trim the angle of attack of the thrust and/or to tilt the unit up, e.g. when not in use.

The configurations of these propulsion systems include one or more complicated attachments to the boat's transom, comprising a hydraulic system, that allows the entire propulsion system to rotate about its steering axis and its trim/tilt axis. The complication is partly due to the multiplicity of rotation axes and partly because the entire system needs to rotate about these axes. Rotating the powerhead requires large forces and adequate space around the transom of the boat for the powerhead to rotate about the steering axis. To accommodate these rotational movements, the powerhead is usually supported well aft of the transom. Consequently, many traditional outboard motors comprise a steering lever that extends within the hull of the boat. This lever is attached to the powerhead and is used to rotate the motor relative to the transom to steer the boat. The lever requires adequate space to rotate and takes up valuable space within the hull of the boat.

It is against this background that the present invention has arisen.

According to the present invention, there is provided an outboard propulsion system comprising a first portion for attachment to a boat, wherein the first portion is fixed about a substantially vertical axis, and a second portion connected to the first portion and configured to rotate about a steering axis, wherein the first portion comprises a sealed housing enclosing a member having a longitudinal axis relative to which it may move and the second portion comprises a gear configured to engage with the member such that movement of the member relative to its longitudinal axis generates rotational movement of the gear about the steering axis, and wherein the sealed housing comprises a sensor configured to determine the position of the member within the sealed housing.

The first portion may be attached to the boat via a fixing mechanism. The fixing mechanism may comprise a transom bracket configured to connect to the boat and a cradle configured to connect to the first portion. The cradle may be connected to the transom bracket and configured to rotate about a substantially horizontal axis. Consequently, the first portion may rotate about a substantially horizontal axis. The substantially horizontal axis may be substantially parallel with the transom of the boat. Alternatively, or in addition, the substantially horizontal axis may be perpendicular to a longitudinal axis of the boat.

Enclosing the member within a sealed housing that is fixed about a substantially vertical axis enables the first portion to be extended down over the gear with which the member engages. This enables the positioning of connections between the outboard propulsion system and the cradle to be optimised. For example, the cradle may be connected to the first portion at a location that is positioned closer to the water level than the gear. This allows a larger engine to be used for a given bracket and/or cradle size. Alternatively, or in addition, a connection between the first portion and the cradle may be optimally positioned towards the bottom of the first portion. For example, a connection between the first portion and the cradle may be optimally positioned less than 500 mm, 300 mm, 200 mm or 100 mm from the bottom of the first portion.

Furthermore, enclosing the movable member within the sealed housing within the first portion of the outboard propulsion system enables the member to be protected from the external environment, such as seawater and marine life. Consequently, the gear may be configured to engage with the member within the protection of the first portion, thus allowing all moving parts of the steering system to be internal. Alternatively, or in addition, the gear may be configured to engage with the member within the protection of the sealed housing, thus allowing all moving parts of the steering system to be internal.

The sealed housing may be configured to enclose the entire first portion. For example, the sealed housing may enclose each member and the engine, in addition to any other components within the first portion. Consequently, the sealed housing may be the cowling or a part thereof. This reduces the number of seals between the internal components of the first portion and the external environment, thus resulting in a more robust system. Accordingly, the sealed housing may be the first portion and/or a cowling. The first portion may be attached to the stern of a boat.

Alternatively, the sealed housing may be a discrete element within the first portion, thus ensuring that the member remains enclosed when another element of the first portion, such as a cowling, is removed. For example, the sealed housing may be a steering arrangement housing.

The sensors enable the steering direction to be accurately monitored and adjusted electronically via the helm. For example, the outboard propulsion system may be ‘steered by wire’. This improves the responsiveness and packaging of the system.

The member may comprise a magnet. The sensor may be configured to monitor the change in magnetic field produced by the magnet in order to determine the position of the member within the sealed housing.

The magnet may be located within the member. For example, the magnet may be contained within the member. Locating the magnet within the member does not alter the profile of the member, thus preventing the sealed housing from needing modification.

Alternatively, the magnet may be located on an outer surface of the member. The magnet may be recessed into an outer surface of the member. Alternatively, or in addition, the magnet may be shaped to wrap around the member. For example, the magnet may be helical. Wrapping the magnet around the member produces larger variations in the magnetic field when the member is moved, thus increasing the accuracy and precision with which the sensor can determine the position of the member.

In some embodiments, the sensor may be a non-contacting sensor. The sensor may be located externally of the sealed housing. For example, the sensor may be configured to detect movement of the member from outside the sealed housing. This ensures that no additional sealing of the housing is required and ensures that sensor replacement and/or maintenance is simplified.

The first portion may comprise an engine and the second portion may comprise a propeller shaft. The engine may be configured to provide motive power to the propeller shaft.

The gear may be connected to the second portion, such that rotation of the gear causes rotation of the second portion relative to the first portion. When the gear is fixed to the second portion, it does not move relative to the second portion. The second portion may be configured to generate thrust. More specifically, the propeller shaft may be configured to generate thrust, in use. Therefore, rotating the second portion relative to the first portion, via the gear, may change the direction of the thrust being generated. Changing the direction of the thrust being generated may be used to steer the boat.

The first portion may comprise a transmission assembly configured to control the motive power provided to the propeller shaft. For example, the transmission assembly may be configured to control motive power provided to the propeller shaft via at least one drive shaft. Locating the transmission assembly in the first portion and therefore above the steering arrangement allows the first portion to extend down closer to the water level, in use. This allows the positioning of at least one additional connection between the first portion and the cradle to be optimised. This may reduce vibrations on the boat and increase the stability of the outboard propulsion system, in use.

The steering axis may be non-vertical. A non-vertical steering axis may enable the thrust generated by the system to comprise a vertical component which may improve the dynamic behaviour of the boat during turns and/or lower the bow of the boat and reduces the likelihood of the boat skidding across the water surface during a turn.

The member may be operably connected to a motor configured to generate movement of the member relative to its longitudinal axis. The motor may be connected to a control system, such as a helm of the boat, which may be configured to control the movement of the member, thus rotating the gear and enabling a user to change the direction of thrust generated by the outboard propulsion system.

Alternatively, or in addition, the member may be operably connected to a hydraulic pump configured to generate movement of the member relative to its longitudinal axis. The hydraulic pump may be connected to a control system, such as a helm of the boat, which may be configured to control the movement of the member, thus rotating the gear and enabling a user to change the direction of thrust generated by the outboard propulsion system.

The member may comprise at least one protrusion. The protrusion may enable engagement with the gear. The protrusion may be a tooth. Alternatively, the protrusion may be a screw thread. Alternatively, or in addition, the gear may comprise at least one protrusion configured to engage with the member. Consequently, the gear may be configured to engage with the member.

The member may be elongate. An elongate member increases the length over which the member is able to engage with the gear, thus enabling larger rotational movements of the gear.

The member may move along its longitudinal axis. Moving a member along its longitudinal axis may result in a rack and pinion steering arrangement. For example, the member may be a rack and the gear may be a pinion gear. Rack and pinion steering arrangements are more compact and robust than some alternative steering arrangements.

The member may move around its longitudinal axis. Alternatively, or in addition, the member May move about its longitudinal axis. Moving the member around its longitudinal axis may result in a worm-drive steering arrangement. For example, the member may be a screw and the gear may be a worm gear, thus resulting in a worm-drive steering arrangement.

Alternatively, or in addition, the member may be directly connected to the motor. The motor may be configured to rotate the member in a first direction, thus rotating the gear in a second direction. Reversing the motor may rotate the member in a third direction, opposite to the first, thus causing rotation of the gear in a fourth direction, opposite to the second.

The member may move both along its longitudinal axis and about its longitudinal axis. For example, the hydraulic fluid may cause both rotational and axial movement of the member within the sealed housing.

The sealed housing may comprise a cylinder having a chamber configured to receive a hydraulic fluid. The chamber may be adjacent to the member. The cylinder may comprise an inlet in fluid communication with the chamber. The chamber may receive the hydraulic fluid via the inlet.

A cylinder comprising a chamber configured to receive a hydraulic fluid may be used to move each member relative to its longitudinal axis. The motor may be configured to pump hydraulic fluid into the chamber, thus enabling the removal of any vibrations caused by the engine from the vicinity of the motor. The hydraulic fluid within the chamber may exert a pressure on the member, thus moving it relative to its longitudinal axis.

The chamber may comprise an outlet configured to control the flow of hydraulic fluid out of the chamber. The hydraulic fluid in the chamber may be in fluid communication with a reservoir. The outlet may comprise a valve configured to control the flow of hydraulic fluid from the chamber to the reservoir. When the valve is closed, the motor may pump hydraulic fluid from the reservoir into the chamber, which may pressurise the chamber and/or cause the member to move relative to its longitudinal axis in a first direction. When the valve is opened, the pressure within the chamber may reduce, thus causing the member to move relative to its longitudinal axis in a second direction.

Alternatively, in some embodiments, the inlet is also the outlet. The motor may be configured to power a pump configured to pump the fluid from the reservoir into the chamber, thus pressurising the chamber and/or causing the member to move relative to its longitudinal axis in a first direction. The motor may be reversed, thus depressurising the chamber and/or causing fluid to flow from the chamber back into the reservoir. Alternatively, the motor may be switched off and the fluid may flow from the chamber back to the reservoir under gravity.

The sealed housing may comprise a cylinder having two chambers separated by the member. Each chamber may be configured to receive a hydraulic fluid. Consequently, the sealed housing may comprise a single double-acting member.

Each chamber may be configured to receive a hydraulic fluid via at least one inlet. The member may comprise at least one seal configured to restrict the flow of fluid between the chambers within the cylinder. Each chamber may be configured to receive a hydraulic fluid.

Alternatively, or in addition, there is also provided an outboard propulsion system comprising a first portion for attachment to a boat, wherein the first portion is fixed about a substantially vertical axis, and a second portion connected to the first portion and configured to rotate about a steering axis, wherein the first portion comprises a sealed housing enclosing two members, each having a longitudinal axis relative to which it may move, and wherein the gear is configured to engage with each member such that movement of at least one member relative to its longitudinal axis generates rotational movement of the gear about the steering axis.

The sealed housing may comprise a plurality of cylinders. More specifically, the sealed housing may comprise two cylinders. Each cylinder may comprise a chamber configured to receive hydraulic fluid.

The first and second member may be positioned such that rotational movement of the gear causes movement of the first member in a first direction and movement of the second member in a second direction. The first direction may be the opposite direction to the second direction.

Two members that move in opposing directions when the gear is rotated may reduce backlash within the system. In some embodiments, two members that move in opposing directions when the gear is rotated may remove backlash from within the system. Moreover, two members that move in opposing directions when the gear is rotated may also reduce that amount of vibration that is generated within the system, thus minimising the risk of resonance. Accordingly, the vibration transferred throughout the system and to the hull of the boat is also reduced, thus reducing the stress induced on all components within the system.

The first member may be moved in a first direction as a result of the increase in pressure in a first chamber. The first chamber may be adjacent to the first member. Movement of the first member may cause movement of the gear. Movement of the gear may cause movement of a second member in a second direction. Movement of the second member in a second direction may force fluid out of a second chamber. The second chamber may be adjacent to the second member. The first member may be located within a first cylinder. The first chamber may be located within a first cylinder. The second member may be located in a second cylinder. The second chamber may be located in a second cylinder.

Alternatively, or in addition, the second member may be moved in the first direction as a result of the increase in pressure in the second chamber. Movement of the second member may cause movement of the gear. Movement of the gear may cause movement of the first member in the second direction. Movement of the first member in a second direction may force fluid out of the first chamber. Consequently, the sealed housing may comprise two single acting members.

Alternatively, or in addition, there is provided an outboard propulsion system comprising: a first portion for attachment to a boat, wherein the first portion is fixed about a substantially vertical axis, and a second portion connected to the first portion and configured to rotate about a steering axis, wherein the first portion comprises a sealed housing enclosing a first and second member each having a longitudinal axis, wherein the second portion comprises a gear including at least one protrusion configured to engage with each member, and wherein each protrusion is configured to move along the longitudinal axis of the corresponding member in order to rotate the second portion about the steering axis.

The gear may be substantially circular. The at least one protrusion may be configured to move in a substantially curved or arc-like path. The chord of the curved or arc-like pathway may be parallel or substantially parallel to the longitudinal axis of the member.

Rotational movement of the gear may cause movement of the first member in a first direction. Alternatively, or in addition, rotational movement of the gear may cause movement of the second member in a second direction. The second direction may be opposite to the first direction. For example, the first and second members may be positioned on opposing sides of the gear.

Alternatively, in some embodiments, the first member may be positioned adjacent to the second member. Nevertheless, the first member may also be configured to move in an opposing direction to the second member.

Alternatively, or in addition, the sealed housing may comprise two cylinders, each having two chambers separated by a member. Each chamber may be configured to receive hydraulic fluid. Consequently, the sealed housing may comprise two double acting members.

The motor may pump hydraulic fluid from the reservoir into a first chamber within each cylinder to pressurise a first chamber within each cylinder. Pressurising a first chamber within each cylinder may cause each member to move relative to its longitudinal axis. The first member may move in a first direction and the second member may move in a second direction. The first direction may be the opposite direction to the second direction. Simultaneously, fluid in the second chamber within each cylinder may flow back into the reservoir.

The pump may then be reversed, thus causing hydraulic fluid to flow from the reservoir into the second chamber within each cylinder. Pumping hydraulic fluid into the second chamber within each cylinder may pressurise the second chamber, thus causing the first and second members to move relative to their longitudinal axis in the second and first directions, respectively. Simultaneously, fluid in the first chamber within each cylinder may flow into the reservoir.

Alternatively, or in addition, at least one hydraulic control valve may be configured to direct the hydraulic fluid being pumped from the reservoir into the first and/or second reservoirs within each cylinder.

Two double-acting members may provide a level of redundancy to the system. This may enable the gear to be rotated even if one member disengages with the gear or the ability of a user to move one of the members is impaired or restricted. Each of the members may be located on opposing sides of the gear, thus resulting in parallel and offset longitudinal axes. Consequently, rotation of the gear may cause each of the members to move in opposing directions relative to their axis.

In some embodiments, each member may initially operate as a single acting member, thus preventing hydraulic fluid from entering the second chamber within the cylinder. Consequently, the backlash within the system may be reduced. Alternatively, or in addition, the backlash within the system may be removed entirely. In use, the cylinder may be configured to switch to double-acting, thus allowing hydraulic fluid to enter the second chamber within the cylinder only when needed. The flow of fluid into the second chamber within the cylinder may be controlled via a second pump and/or at least one valve. The valve may be a bespoke valve. In some embodiments, the member may be configured to be single-acting when the gear is located near to the neutral steering position.

Consequently, there may be a plurality of members. Each member may be single acting. Alternatively, or in addition, each member may be double-acting.

Alternatively, or in addition, the outboard propulsion system may comprise a conduit providing fluid communication between the first and second portion. Therefore, there is also provided an outboard propulsion system comprising a first portion for attachment to a boat, wherein the first portion is fixed about a substantially vertical axis; a second portion connected to the first portion and configured to rotate about a steering axis, wherein the first portion comprises a sealed housing enclosing a member having a longitudinal axis relative to which it may move and the second portion comprises a gear configured to engage with the member such that movement of the member relative to its longitudinal axis generates rotational movement of the gear about the steering axis, and a conduit providing fluid communication between the first and second portion. A conduit providing fluid communication between the first and second portion enables fluid, such as exhaust gas and water, to be transported throughout the system. The fluid may be a liquid and/or a gas.

The conduit may pass from the first portion directly into the second portion. Alternatively, or in addition, the conduit may pass from the second portion directly into the first portion. Passing the conduit from the first portion directly into the second portion minimises the length of the conduit, thus increasing the efficiency of the system. Passing the conduit from the first portion directly into the second portion also reduces the overall packaging size of the system.

The conduit between the first and second portion may be substantially linear. A substantially linear conduit between the first and second portion further increases the efficiency of the system and further reduces the overall packaging size of the system.

The conduit may pass through an aperture in the gear. Passing the conduit through an aperture in the gear further reduces the length of the conduit. Moreover, passing the conduit through an aperture in the gear enables the conduit to be positioned around the centre of rotation. For example, the centroid of the conduit in the vicinity of the gear may be aligned with the steering axis.

The outboard propulsion system may comprise a drive shaft configured to transfer motive power between the first and second portion. A portion of the drive shaft may be located within the conduit.

The outboard propulsion system may comprise a sleeve located within the conduit. The sleeve may be configured to enclose a portion of the drive shaft.

Locating the drive shaft within the conduit reduces the overall packaging size of the system, thus reducing the overall weight. The sleeve may protect the drive shaft from the fluids within the conduit. Consequently, the sleeve increases the robustness of the system and prevents the driveshaft from deteriorating away from its optimal condition.

The outboard propulsion system may comprise a second conduit. The second conduit may be configured to enclose the first conduit. The second conduit may be configured to provide fluid communication between the first and second portion. The conduits may be concentric. Enclosing the first conduit within the second conduit enables both water and exhaust gas to be transported throughout the system separately and efficiently. The first conduit may be configured to receive water. The second conduit may be configured to receive exhaust gas. Alternatively, the first conduit may be configured to receive exhaust gas. The second conduit may be configured to receive water.

Alternatively, or in addition, there is provided an outboard propulsion system comprising a first portion for attachment to a boat, wherein the first portion is fixed about a substantially vertical axis, and a second portion connected to the first portion and configured to rotate about a steering axis, wherein the first portion comprises a member having a longitudinal axis relative to which it may move and the second portion comprises a gear configured to engage with the member such that movement of the member relative to its longitudinal axis generates rotational movement of the gear about the steering axis, and wherein the first portion comprises an engageable component having an axis relative to which it may move, wherein the engageable component is operably engaged with the gear such that movement of the engageable component relative to its axis generates rotational movement of the gear about the steering axis.

An engageable component configured to operably engage with the gear such that movement of the engageable component relative to its axis generates rotational movement of the gear about the steering axis may provide redundancy to the outboard propulsion system. For example, in some embodiments, the second portion may be rotated, via the engageable component, even when the member cannot be moved. The engageable component may be used to rotate the second portion in an emergency.

The engageable component may be a toothed disc configured to rotate about an axis passing through its centre. Rotation of the toothed disc about its axis may generate rotational movement of the gear about the steering axis.

A toothed disc enables engagement with the gear, thus enabling a rotational force to be transferred therebetween. The toothed disc may be a gear. The system may comprise a plurality of toothed discs operably connected to the gear. A first toothed disc may comprise a larger diameter than a second toothed disc. The first and second toothed discs may be configured to create a gear ratio. Consequently, the first and second toothed discs may be configured to increase and/or decrease the power output of a turning force provided to the engageable member.

Alternatively, or in addition, the engageable member may be a toothed bar having a longitudinal axis along which it may move. Movement of the toothed bar along its longitudinal axis may generate rotational movement of the gear about the steering axis.

A toothed bar may be used instead of a toothed disc. The toothed bar may be a member comprising a plurality of protrusions. The plurality of protrusions may be teeth. A bar may reduce the overall packing size compared to a disc. In some embodiments, the toothed bar may be operably connected to a toothed disc. The toothed bar may be operably connected to a plurality of toothed discs. The plurality of toothed discs may be configured to create a gear ratio, as described above.

Alternatively, or in addition, the engageable member may be a threaded bar having a longitudinal axis about which it may move. Movement of the threaded bar about its longitudinal axis may generate rotational movement of the gear about the steering axis.

A threaded bar may be used instead of a toothed disc and/or toothed bar. The threaded bar may comprise a single elongate protrusion. In some embodiments, the threaded bar may be operably connected to a toothed disc. The threaded bar may be operably connected to a plurality of toothed discs. The plurality of toothed discs may be configured to create a gear ratio, as described above.

Furthermore, a threaded bar may provide a steering lock configured to ensure that movement of the gear is only achievable via the engageable member. This enables users to lock the steering position via the engageable member in a scenario where the member is free to move. This may occur if fluid has leaked from the hydraulic system.

The outboard propulsion system may further comprise a handle configured to engage the engageable member with the gear. Alternatively, the handle may be a button. For example, in some embodiments, the engageable member may be engaged and disengaged from the gear via the handle. However, in some embodiments, the engageable member is always operably coupled to the gear.

The handle may be configured to generate engagement between the engageable member and the gear, in use. Engagement of the engageable member with the gear may enable movement of both the gear and the member via the engageable member. Moreover, in some embodiments, engagement of the engageable member may prevent movement of the member. Consequently, the engageable member may be required to disengage with the gear during normal use to enable the member to rotate the gear.

Movement of the engageable member may generate rotational movement of the gear about the steering axis and movement of the member relative to its longitudinal axis. This enables a user to override any input provided to the member, thus giving a user full control of the rotation of the second portion.

The gear may comprise a plurality of protrusions configured to engage with the engageable member. The protrusions may be positioned around at least 30% of the circumference of the gear. The plurality of protrusions may be teeth. A gear comprising a plurality of protrusions positioned around at least 30% of the circumference of the gear and configured to engage with the engageable member may enable the gear to be rotated through at least 108 degrees via movement of the engageable member.

In some embodiments, as described in more detail above, the member may comprise at least one protrusion. The plurality of protrusions on the gear may also be configured to engage with the at least one protrusion on the member. Protrusions positioned around at least 30% of the circumference of the gear may be enable movement of the member and the engageable member without either of them disengaging from the gear.

In some embodiments, the outboard propulsion system may comprise two members. Consequently, the plurality of protrusions may be positioned around at least 60% of the circumference of the gear and may be configured to engage with the at least one protrusion on each of the members and the engageable member.

In some embodiments, the gear may comprise protrusions positioned around at least 30%, 40%, 50%, 60%, 70%, 80%, 90% or 100% of its circumference.

The engageable member may be directly connected to the gear. Directly connecting the engageable member to the gear may reduce the overall packaging size of the system. Furthermore, directly connecting the engageable member to the gear may simplify the system in order to reduce the number of components that may fail, wear out or need replacing.

Alternatively, the engageable member may be connected to the gear via at least one intermediate gear. The engageable member may be connected to the gear via a plurality of intermediate gears. The intermediate gear may be configured to increase the torque, moment and/or rotational force applied to the gear, in use. Consequently, the intermediate gear may have a smaller diameter than the gear. Alternatively, or in addition, the intermediate gear may have a larger diameter than the engageable member. A plurality of intermediate gears may have a plurality of different diameters.

The engageable member may be operably connected to a motor configured to move the engageable member relative to its axis. The motor may be controllable via the helm of a boat, in use. Alternatively, or in addition, the motor may be controllable via a button on or attached to the outboard propulsion system. The motor may be configured to receive power from a battery. Alternatively, or in addition, the motor may be configured to receive power from the outboard propulsion system.

The engageable member may be operably connected to an actuator. The actuator may be configured to be manually rotated by a user. Moreover, the actuator may be configured to receive a lever adapted to assist the user with rotation of the actuator. The lever may be a spanner. A manually operated actuator configured to rotate the engageable member may be used to ensure that the second portion of the outboard propulsion system can be rotated mechanically and is not reliant on electronic signals and/or hydraulic fluid. This reduces the likelihood of total failure of the steering system. Alternatively, or in addition, the actuator may be configured to be rotated by the outboard motor. Moreover, in some embodiments, the actuator may be configured to be rotated by a separate motor. The motor may be battery operated and/or may be controlled from the helm of the boat.

Consequently, the engageable member may be configured to receive energy from at least one of a user, the outboard motor and a battery, thus providing redundancy within the system. Furthermore, a user is able to move the engageable member using an energy source that is most convenient for them and/or from a location on a boat that is most desirable for a given situation.

The engageable member may be operably connected to the actuator via a flexible shaft. A flexible shaft may be used to improve the packaging of the system. A flexible shaft may be configured to connect the engageable member to the actuator via a tortuous path. Alternatively, the engageable member may be operably connected to the actuator via a plurality of rigid shafts each connected to an adjacent rigid shaft via a rotatable joint, such as a universal joint. Alternatively, the engageable member may be operably connected to the actuator via at least one rigid shaft. The engageable member may be operably connected to the actuator via a single rigid shaft.

The actuator may be accessible by a user located inside the boat, in use. Enabling a user to access the actuator from inside the boat allows the user to rotate the second portion, thus steer the boat, from within the boat. This is of particular advantage to a user if control of the outboard propulsion system via the helm of the boat is lost, in use.

As previously disclosed, the first portion may comprise a sealed housing configured to enclose the member. Alternatively, or in addition, the sealed housing may be configured to enclose the engageable member.

Enclosing the engageable member within the sealed housing protects the engageable member from the external environment, such as seawater and marine life. Consequently, the gear may be configured to engage with the engageable member within the protection of the first portion, thus allowing all moving parts of the steering system to be internal.

Alternatively, the sealed housing may comprise an additional chamber configured to enclose the engageable member. The additional chamber may be attached to a main body of the sealed housing. The connection between the main body of the sealed housing and the additional chamber may be substantially fluid tight.

Again, as previously disclosed, the sealed housing may comprise a cylinder having a chamber configured to receive a hydraulic fluid from a reservoir via an inlet. The cylinder may comprise a first chamber and a second chamber separated by the member. Each chamber may be configured to receive a hydraulic fluid from a reservoir via an inlet. The first chamber may be in fluid communication with the second chamber via the reservoir.

Alternatively, or in addition, the sealed housing may enclose two members, each having a longitudinal axis relative to which it may move. The gear may be configured to engage with each member such that movement of at least one member relative to its longitudinal axis generates rotational movement of the gear about the steering axis. Consequently, the sealed housing may comprise a first cylinder having a first chamber and a second cylinder having a second chamber. Each chamber may be configured to receive a hydraulic fluid from a reservoir via an inlet. The first chamber may be in fluid communication with the second chamber via the reservoir.

The outboard propulsion system may further comprise a switch configured to generate direct fluid communication between the first chamber and the second chamber. A switch configured to generate direct fluid communication between the first and second chamber enables the gear to be rotated even when hydraulic fluid is unable to return to the reservoir.

In some embodiments, the switch is configured to operate an override valve. Alternatively, or in addition, the override valve may be operated manually by a user. Consequently, the override valve may be a manual override valve. In a first position, the manual override valve allows hydraulic fluid within the system to flow between the first and second chamber via the reservoir. However, in a second position, the manual override valve enables hydraulic fluid to flow from the first chamber directly to the second chamber.

The outboard propulsion system may comprise a locking mechanism operable between a first position configured to allow movement of the engageable member relative to its axis and a second position configured to prevent rotation of the engageable member relative to its axis. The locking mechanism may be a shuttle valve configured to control the flow of hydraulic fluid into and/or out of the reservoir. The shuttle valve may be controlled electronically.

The locking mechanism may be used to fix the position of the second portion relative to the first portion. This may provide a constant steering direction, which may be used to maintain the heading of a boat, in use. The locking mechanism may also be configured allow movement of the member relative to its axis when in the first position and prevent movement of the member relative to its axis when positioned in the second position. The locking mechanism may control the flow of hydraulic fluid within the system. For example, the first position may enable the flow of hydraulic fluid within the system whereas the second position may prevent the flow of hydraulic fluid within the system.

Alternatively, or in addition, the outboard propulsion system may comprise a lockable collar configured to prevent movement of the first portion relative to the second portion. The lockable collar may be operably connected to the actuator. Alternatively, or in addition, the lockable collar may be operably connected to the engageable member. The lockable collar may be operably connected to the engageable member via a shaft.

More specifically, the lockable collar may comprise a first position configured to allow rotation of the second portion relative to the first portion. Moreover, the lockable collar may comprise a second position configured to prevent rotation of the second portion relative to the first portion. The lockable collar may be moved between the first position and the second position manually. Consequently, in the second position, the lockable collar may allow the direction and/or orientation of second portion relative to the first portion to be maintained. This is particularly advantageous in a situation where the system comprises an inadequate amount of hydraulic fluid. This may occur if the hydraulic system comprises a leak, for example.

Moreover, the lockable collar may be fixed in either of the first and second positions. More specifically, the lockable collar may comprise a lock configured to prevent movement of the lockable collar between the first and second positions.

The lockable collar may be configured to engage with the actuator. Accordingly, the lockable collar may prevent rotation of the actuator, which may in turn prevent rotation of the engageable member and the gear.

The invention will now be further and more particularly described, by way of example only, with reference to the accompanying drawings, in which:

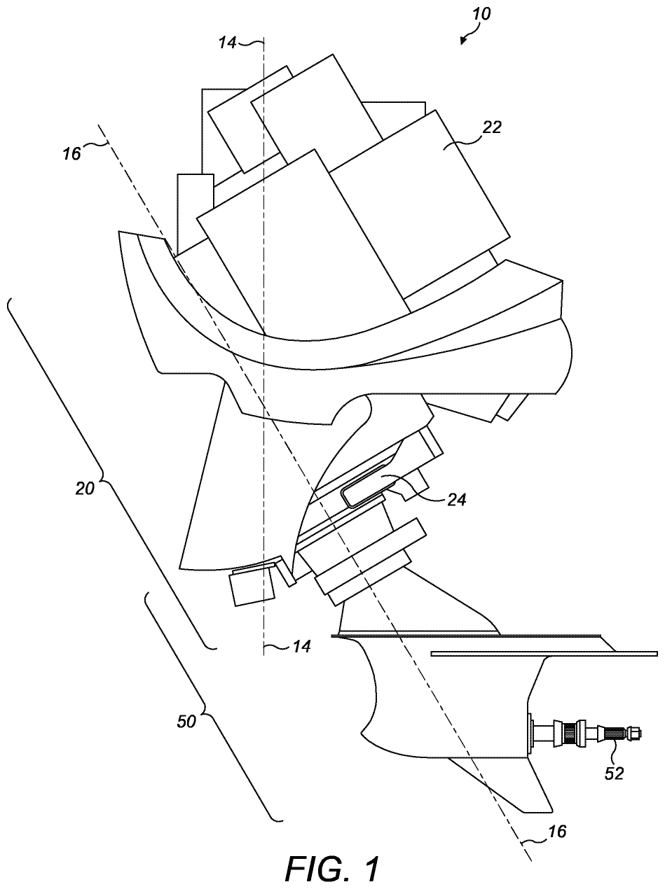

FIG. 1 shows an outboard propulsion system according to some embodiments of the present invention;

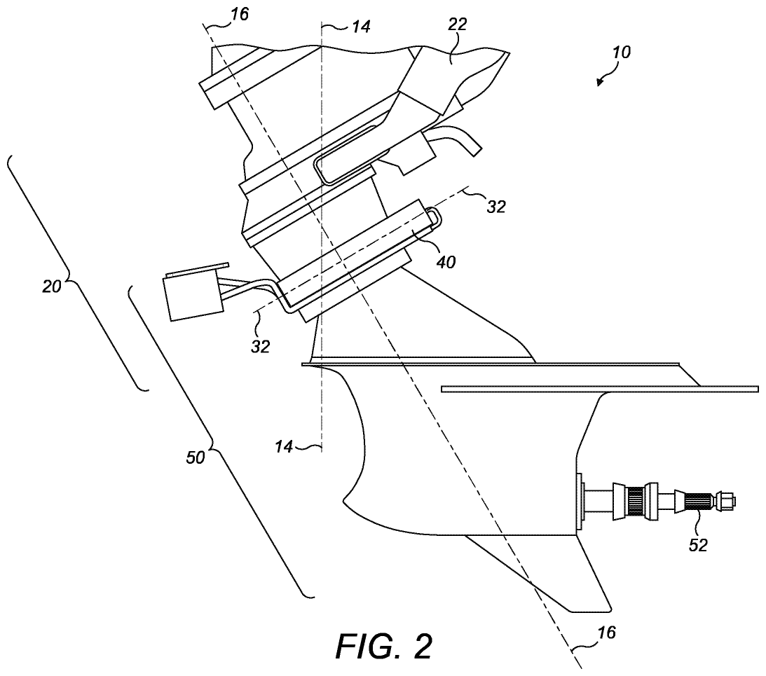

FIG. 2 shows a sealed housing according to some embodiments of the present invention;

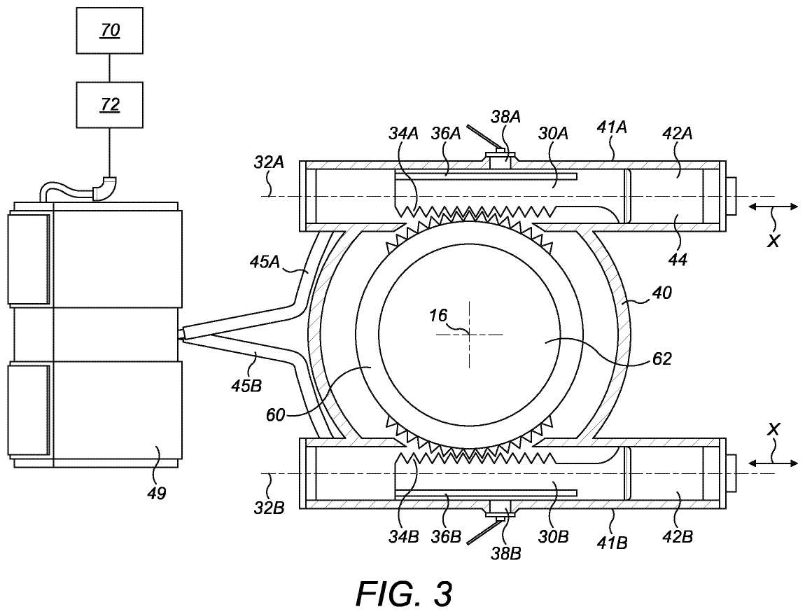

FIG. 3 shows an embodiment of the invention comprising a rack and pinion steering arrangement;

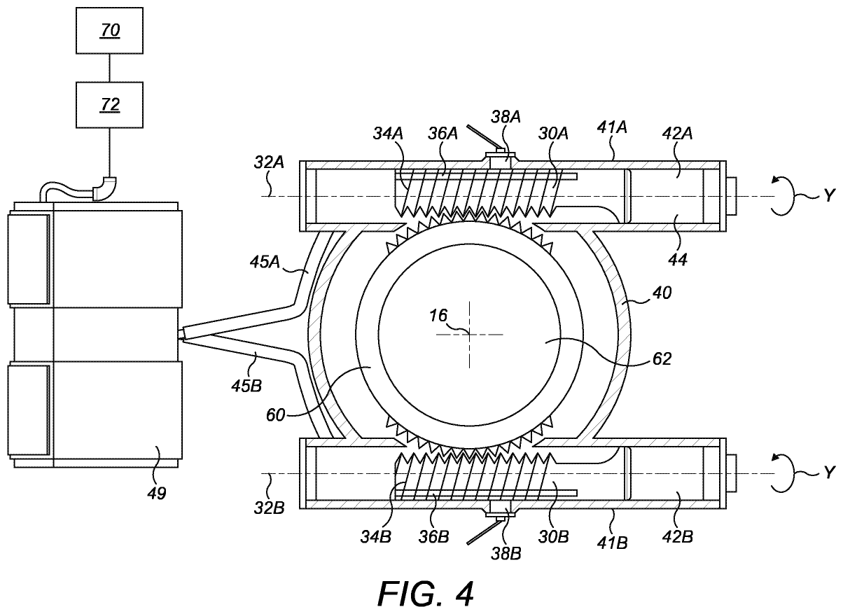

FIG. 4 shows an embodiment of the invention comprising a worm-drive steering arrangement;

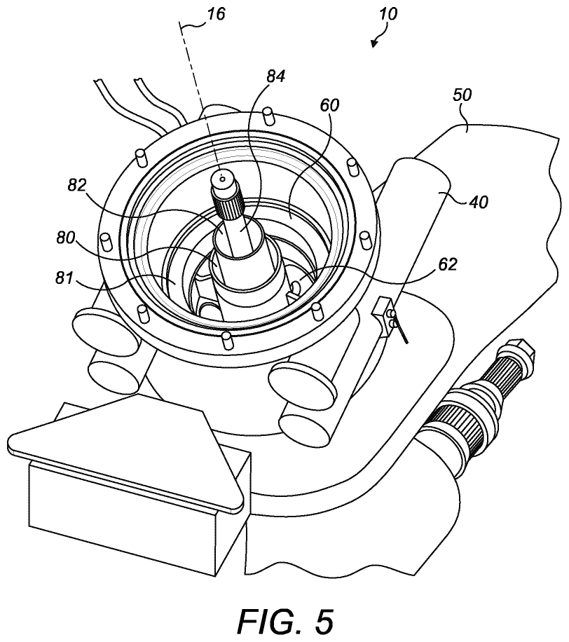

FIG. 5 shows an embodiment of the invention comprising two concentric conduits providing fluid communication between the first and second portion;

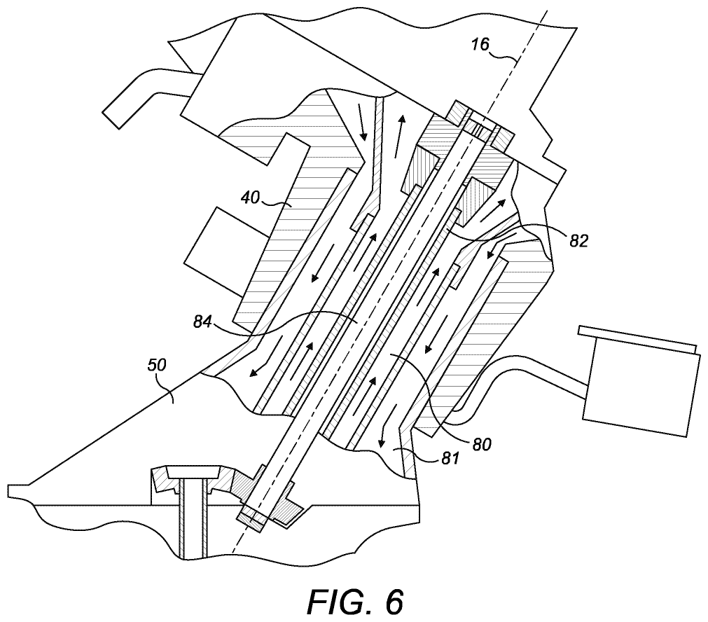

FIG. 6 shows a section through the outboard propulsion system shown in FIG. 5;

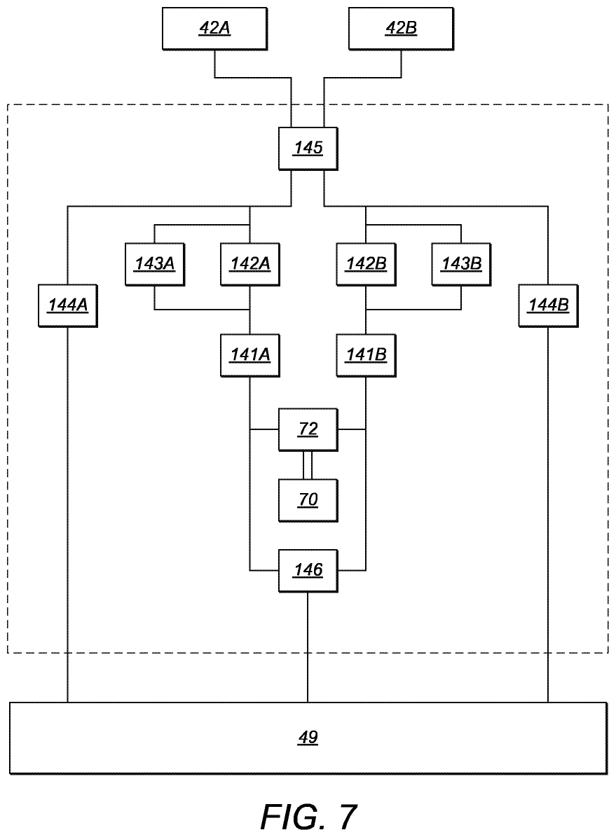

FIG. 7 shows schematically the configuration of a plurality of valves configured to control the flow of hydraulic fluid through the outboard propulsion system shown in FIG. 5;

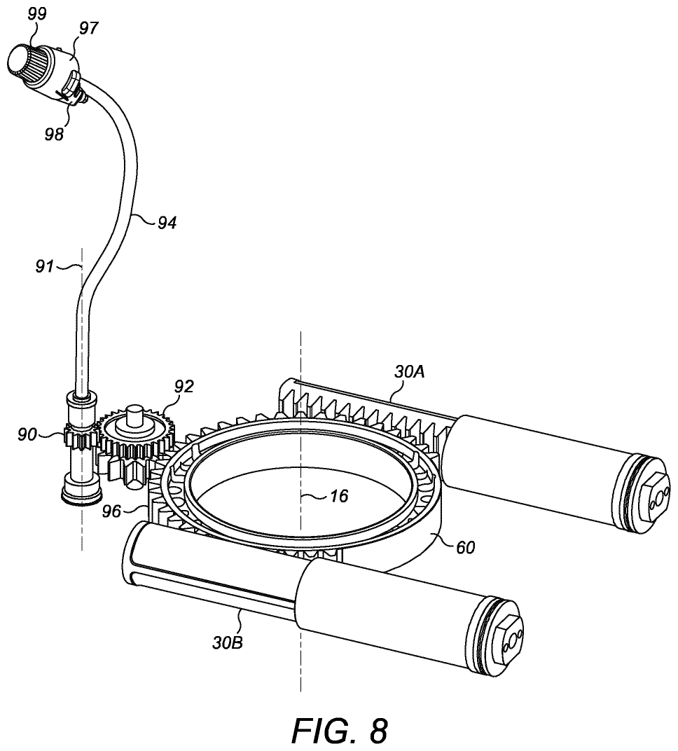

FIG. 8 shows an embodiment of the invention comprising an engageable member;

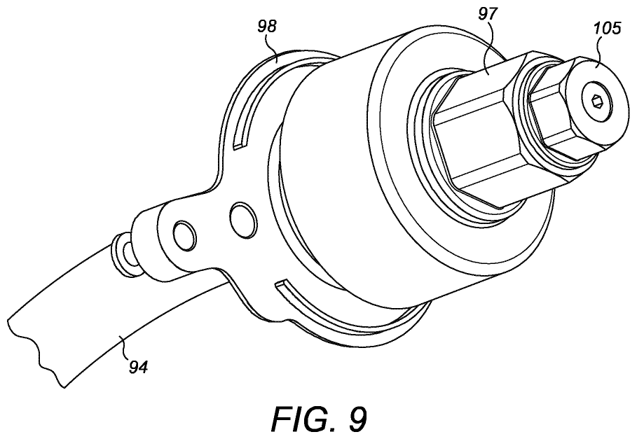

FIG. 9 shows the actuator;

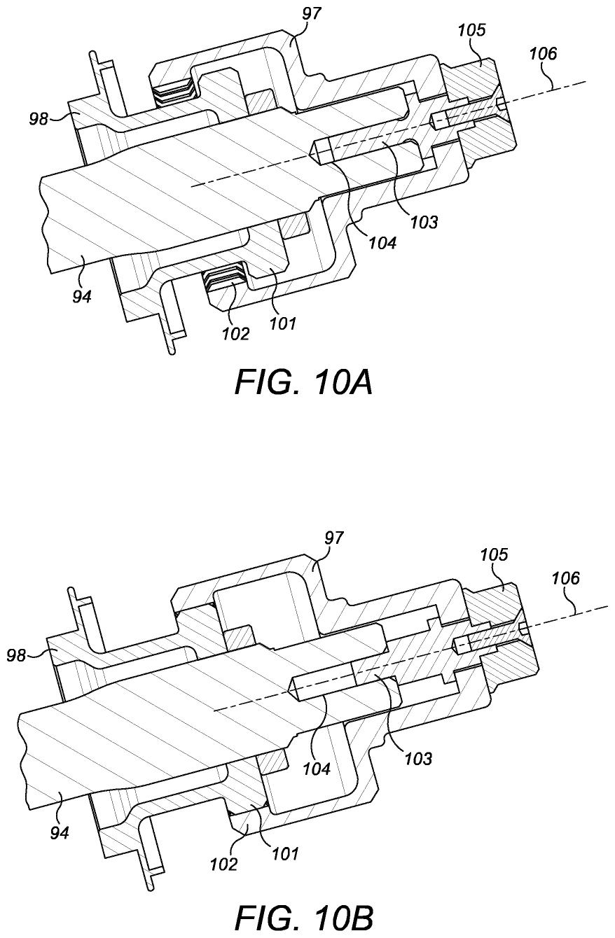

FIG. 10A shows a section through the actuator when the lockable collar is disengaged, and

FIG. 10B shows a section through the actuator when the lockable collar is engaged.

FIG. 1 shows an outboard propulsion system 10 comprising a first portion 20 for attachment to a boat. More specifically, the first portion 20 is attached to the stern of a boat via a cradle or bracket. However, any suitable means for connecting the outboard propulsion system to the boat may be used.

The first portion 20 is fixed about a substantially vertical axis 14. Alternatively, or in addition, in some embodiments, not shown, the first portion 20 may be fixed about a substantially vertical plane.

The first portion 20 comprises an engine 22 and a transmission assembly 24. The engine 22 is a traditional four-stroke compression ignition diesel engine. However, any internal combustion engine may be used. In some embodiments, the engine runs on diesel, whereas in other embodiments the engine runs on petrol. Moreover, in some embodiments, the engine is a hybrid and comprises at least one battery, at least one electric motor and an internal combustion engine. In some embodiments, not shown, the outboard propulsion system is fully electric and comprises one or more electric motor and corresponding battery. The transmission assembly 24 is configured to control the motive power output from the engine 22.

The outboard propulsion system 10 further comprises a second portion 50 connected to the first portion and configured to rotate about a steering axis 16. The second portion 50 comprises a propeller shaft 52 configured to generate thrust. The engine 22 is configured to provide motive power to the propeller shaft 52, thus generating thrust. The transmission assembly 24 is configured to control the motive power provided to the propeller shaft 52.

The steering axis 16 is non-vertical. In some embodiments, the steering axis 16 may intersect a longitudinal axis of the at least one propeller shaft 52 at an angle between 100 degrees and 140 degrees. Alternatively, or in addition, the steering axis 16 may intersect the longitudinal axis of the at least one propeller shaft 52 at an angle of about 120 degrees. However, in some embodiments, not shown, the steering axis 16 may intersect the longitudinal axis of the at least one propeller shaft 52 at an angle between 90 and 180 degrees, 95 and 160 degrees, 100 and 140 degrees, 110 and 130 degrees, 115 and 125 degrees or about 120 degrees.

In some embodiments, the steering axis 16 may intersect the substantially vertical axis 14 at an angle between 40 degrees and 80 degrees. Alternatively, or in addition, the steering axis 16 may intersect the substantially vertical axis 14 at an angle of about 60 degrees. However, in some embodiments, not shown, the steering axis 16 may intersect the substantially vertical axis 14 at an angle between 0 and 90 degrees, 20 and 85 degrees, 40 and 80 degrees, 50 and 70 degrees, 55 and 65 degrees or about 60 degrees.

As shown in FIGS. 3 and 4, the first portion 20 comprises a sealed housing 40 having a first cylinder 41A and a second cylinder 41B. The cylinder 41A encloses a first member 30A and the second cylinder 41B encloses a second member 30B. Each member 30A, 30B has a longitudinal axis 32A, 32B relative to which they may move, respectively. The second portion 50 comprises a gear 60 configured to engage with the members 30A, 30B such that movement of each member relative to its longitudinal axis 32A, 32B generates rotational movement of the gear about the steering axis 16.

The gear 60 is connected to the second portion 50, such that rotation of the gear 60 causes rotation of the second portion 50 relative to the first portion 20. When the gear 60 is fixed to the second portion 50, it does not move relative to the second portion 50. The second portion 50 is configured to rotate up to 180 degrees relative to the first portion 20. However, in some embodiments, the second portion 50 is configured to rotate up to 40, 60, 80, 90, 100, 120, 140 or 160 degrees relative to the first portion 20. The second portion 50 may rotate clockwise and/or anti-clockwise.

In some embodiments, not shown, the sealed housing 40 is configured to enclose the entirety of the first portion 20. Alternatively, or in addition, the first portion 20 may comprise a discrete sealed housing 40 configured to enclose the first member 30A, second member 30B and the gear 60, as shown in FIGS. 2 to 4.

FIG. 3 shows an embodiment of the invention comprising two members 30A, 30B, each configured to engage with the gear 60. The sealed housing 40 comprises two cylinders 41A, 41B, each comprising a chamber 42A, 42B, respectively. Each chamber 42A, 42B is configured to receive a hydraulic fluid 44 via an inlet (not shown). Each chamber also comprises an outlet (not shown), configured to control the flow of hydraulic fluid out of the chamber and back to the reservoir 49. The hydraulic fluid in each chamber is in fluid communication with a reservoir 49 via a conduit 45A, 45B, respectively. Each conduit provides a fluid pathway between the reservoir 49 and the inlet and/or outlet.

Each member 30A, 30B is elongate and comprises at least one protrusion 34A, 34B configured to engage with the gear 60. Moreover, each member 30A, 30B comprises a magnet 36A, 36B. The sealed housing 40 further comprises at least one sensor 38A, 38B per member, wherein the sensor is configured to determine the position of the magnet within the sealed housing, thus determining the position of each member 30A, 30B and therefore the steering direction. The sensor 38A, 38B, is configured to monitor the position of the magnet based on the change in magnetic field.

However, any suitable magnet and/or sensor may be used. The sensor may be analogue or digital. For example, in some embodiments, a Hall Effect sensor may be used. Alternatively, or in addition, in some embodiments, a magnetic pick-up sensor may be used.

In use, a motor 70 powers a pump 72 which pumps the hydraulic fluid 44 from the reservoir 49 along the first conduit 45A and into the first chamber 42A via a first inlet. The hydraulic fluid 44 within the chamber 42A exerts a pressure on the member 30A. The pressure from the hydraulic fluid 44 within the chamber 42A may cause the member 30A to move away from a first position in a first direction. Movement of the first member 30A in a first direction causes the gear 60 to rotate in a counter-clockwise direction. Consequently, rotation of the gear 60 causes the second member 30B to move away from a first position in a second direction. Movement of the second member 30B in a second direction forces the hydraulic fluid 44 in the second chamber 42B out of the second chamber 42B, via the outlet, along the second conduit 45B and back into the reservoir 49. Consequently, the second portion 50 is rotated about the steering axis 16 relative to the first portion 20 in a counter-clockwise direction. This process is reversed in order to rotate the second portion 50 about the steering axis 16 in the opposite direction relative to the first portion 20.

For example, in use, a motor 70 powers a pump 72 which pumps the hydraulic fluid 44 from the reservoir 49 along the second conduit 45B and into the second chamber 42B via a first inlet. The hydraulic fluid 44 within the chamber 42B exerts a pressure on the member 30B. The pressure from the hydraulic fluid 44 within the chamber 42B may cause the member 30B to move away from the second position in a first direction. Movement of the second member 30B in a first direction causes the gear 60 to rotate in a clockwise direction. Consequently, rotation of the gear 60 causes the first member 30A to move away from a second position in a second direction. Movement of the first member 30A in a second direction forces the hydraulic fluid 44 in the first chamber 42A out of the first chamber 42A, via the outlet, along the first conduit 45A and back into the reservoir 49. Consequently, the second portion 50 is rotated about the steering axis 16 relative to the first portion 20 in a clockwise direction.

In some embodiments, not shown, at least one outlet comprises a valve configured to control the flow of hydraulic fluid 44 from the chamber 42 to the reservoir 49. The outlet may comprise a plurality of valves. Alternatively, or in addition, the reservoir 49 may comprise at least one valve configured to control the flow of hydraulic fluid 44 from the reservoir 49 to the chamber 42. When the valve is closed, the pump 72 may pump hydraulic fluid from the reservoir 49 into a first chamber 42A, 42B via the inlet, which pressurises the chamber and/or cause the member 30A, 30B to move relative to its longitudinal axis 32A, 32B in a first direction. When the valve is opened, hydraulic fluid flows from the chamber 42A, 42B into the reservoir 49 via the outlet. Consequently, the pressure within the chamber 42A, 42B is reduced, thus enabling the member 30A, 30B to move relative to its longitudinal axis 32A, 32B in a second direction.

FIG. 7, shows schematically the configuration of a plurality of valves configured to control the flow of hydraulic fluid 44 between the reservoir 49 and at least one chamber 42 an the outboard propulsion system 10 described above.

In FIG. 7 the pump 72 is a bi-directional pump configured to receive power from the motor 70. The pump 72 is configured to pump hydraulic fluid from the reservoir 49 into a first chamber 42A via a first user-operated check valve 141A and a first restrictor 142A. Simultaneously, hydraulic fluid will be caused to flow from a second chamber 42B into the reservoir 49 via a second restrictor 142B and a second user-operated check valve 141B. When the pump 72 is turned off, the user-operated check valves 141A, 141B remain in a closed or ‘locked’ position, thus preventing hydraulic fluid flow within the system.

Each user-operated check valve 141A, 141B may be operated between an open and closed position as a result of an electronic signal. Alternatively, or in addition, each user-operated check valve 141A, 141B may be operated between an open and closed position as a result of hydraulic fluid pressure within the system.

Each restrictor 142A, 142B is configured to restrict the flow of hydraulic fluid between the chambers 42A, 42B and the reservoir 49, thus maintaining a predetermined hydraulic fluid pressure within the system. Furthermore, the system comprises a first relief valve 143A and a second 143B located parallel to the first restrictor 142A and the second restrictor 142B, respectively. The relief valves 143A, 143B are configured to limit the maximum hydraulic fluid pressure within the system. Alternatively, or in addition, the relief valves 143A, 143B are configured to control the flow and/or pressure of the hydraulic fluid flowing back into the reservoir 49.

A third relief valve 144A and a fourth relief valve 144B are also present. The third and fourth relief valves 144A, 144B are configured to return fluid to the reservoir 49 if large pressure spikes occur within the system.

The system further comprises a manual override valve 145 located between the restrictors 142A, 142B and the chambers 42A, 42B. When positioned in a first position, the manual override valve enables the system to function as described above. However, when positioned in a second position, the manual override valve is configured to enable fluid to flow directly between the first chamber 42A and the second chamber 42B. This may enable the outboard propulsion system to be steered manually, for example, in an emergency. In some embodiments, the manual override valve 145 is operable between the first and second position via a switch (not shown). The switch may be an electronic switch. The switch may be located at the helm of the boat, in use, and/or on the outboard propulsion system. Consequently, the switch is configured to generate direct fluid communication between the first chamber 42A and the second chamber 42B.

Furthermore, the system comprises a shuttle valve 146 configured to control the flow of hydraulic fluid back into the reservoir 49. The shuttle valve 146 is electronically controlled. Consequently, the shuttle valve may act as a locking mechanism. For example, the shuttle valve can prevent the flow of hydraulic fluid into and/or out of the reservoir 49, thus preventing the member 32 and gear 60 from being able to move relative to their respective axis.

In some embodiments, not shown, each cylinder comprises two chambers separated by a member. Consequently, each cylinder may result in a double-acting hydraulic cylinder comprising a member 30. Alternatively, the sealed housing may comprise two double-acting hydraulic cylinders each comprising a member configured to move in an opposing direction. Each chamber may comprise an inlet and an outlet that are in fluid communication with the reservoir via a separate conduit.

Alternatively, or in addition, a first chamber in a first cylinder may be in fluid communication with a first chamber in a second cylinder. Furthermore, a second chamber in the first cylinder may be in fluid communication with a second chamber in the second cylinder. Consequently, hydraulic fluid may flow between each pair of chambers in opposing cylinders in order to move the member relative to its longitudinal axis.

In some embodiments, each member 30 comprises a plurality of protrusions 34. For example, FIG. 3 shows an embodiment of the invention comprising a rack and pinion steering arrangement. Each member 30A, 30B comprises a plurality of protrusions 34A, 34B in the form of teeth shaped to engage with the gear 60. Each member 30A, 30B moves along its longitudinal axis 32A, 32B, as indicated by the arrow X; thus rotating the gear 60.

In some embodiments, each member 30 comprises a single protrusion 34. The single protrusion may be a continuous screw thread. For example, FIG. 4 shows an embodiment of the invention comprising a worm-drive steering arrangement. Each member 30A, 30B comprises a single protrusion 34A, 34B in the form of a screw thread shaped to engage with the gear 60. Each member 30A, 30B moves around and/or about its longitudinal axis 32A, 32B, as indicated by the arrow Y; thus rotating the gear 60. In FIG. 4, the member may be caused to rotate about its axis via the pressure generated by the hydraulic fluid, as previously described. However, in some embodiments, not shown, each member 30A, 30B is directly connected to the motor 70. The motor is configured to rotate the member in a first or second direction, thus generating rotation of the gear and second portion in a third or fourth direction.

FIG. 5 shows an embodiment of the invention comprising two concentric conduits 80, 81, each providing fluid communication between the first portion 20 and second portion 50. The first conduit 80 is configured to receive water. The second conduit 81 is configured to receive exhaust gas from the engine 22. Each conduit 80, 81 provides fluid communication between the first portion 20 and the second portion 50.

More specifically, each conduit 80, 81 passes from the first portion 20 directly into the second portion 50. Consequently, each conduit 80, 81 provides a fluid pathway directly between the first portion 20 and the second portion 50. The conduits 80, 81 pass through an aperture 62 in the gear 60. Consequently, the centroid of the conduits 80, 81 is aligned with the steering axis 16.

The outboard propulsion system 10 further comprising a drive shaft 84 configured to transfer motive power from the engine 22 within the first portion 20 to the propeller shaft 52 within the second portion 50. In some embodiments, there is plurality of intermediate shafts, gears and/or connections operably coupled to the drive shaft 84. At least one of the intermediate shafts, gears and/or connections is located between the engine 22 and propeller shaft 52. Consequently, ‘coupled to’ includes both directly and indirectly coupled to. For example, in some embodiments, the transmission 24 is located between the engine 22 and the driveshaft 84. Consequently, at least one additional drive shaft, not shown, may be located between the engine 22 and the transmission 24.

A portion of the drive shaft 84 is located within the first conduit 80, as shown in FIG. 5. The drive shaft 84 is enclosed by a sleeve 82 configured to prevent fluid within the conduits 80, 81 from coming into contact with the drive shaft 84. The second conduit 81 encloses the first conduit 80 and provides additional fluid communication between the first portion 20 and the second portion 50. Each conduit is configured such that fluid with the first conduit cannot mix with fluid in the second conduit. In some embodiments, the first conduit 80 is configured to receive water and the second conduit 81 is configured to receive exhaust gas.

FIG. 6 shows a section through the outboard propulsion system 10 shown in FIG. 5. More specifically, FIG. 6 shows the conduits 80, 81 passing directly from the first portion 20 into the second portion 50. Alternatively, or in addition, FIG. 6 shows the conduits 80, 81 passing directly from the second portion 50 into the first portion 20.

FIG. 8 shows an embodiment of the outboard propulsion system 10 comprising an engageable member 90. The engageable member 90 has an axis 91 relative to which it is configured to move. In some embodiments, the engageable member is a toothed disc, such as a gear, which is configured to rotate about or around its axis 91, as shown in FIG. 8. Alternatively, in some embodiments, not shown, the engageable member is a toothed bar, such a rack, which moves along its axis or a threaded bar, such as a screw thread, which rotates about or around its axis.

In FIG. 8, the engageable member 90 is operably coupled to the gear 60 via an intermediate gear 92. However, in some embodiments, not shown, the engageable member 90 is directly coupled to the gear 60. Alternatively, or in addition, in some embodiments, not shown, the outboard propulsion system comprises a handle configured to cause engagement of the engageable member 90 with the gear 60 and/or intermediate gear 92.

The intermediate gear 92 is configured to increase the rotational force provided to the gear 60 by the engageable member 90. Any number of intermediate gears 92 may be used. For example, some embodiments comprise 0, 1, 2, 3, 4, 5, 6, 7, 8, 9, 10 or more than 10 intermediate gears 92.

The gear 60 comprises a plurality of protrusions 96 configured to engage with the engageable member 90 and/or the intermediate gear 92. As shown in FIG. 8, the protrusions 96 are positioned around at least 30%, more specifically 50% and most specifically 75% of the circumference of the gear 60.

The engageable member 90, as shown in FIG. 8, is enclosed within the sealed housing 40. However, in some embodiments not illustrated in the accompanying drawings, the sealed housing comprises an additional chamber configured to attach to a main body of the sealed housing 40 and enclose the engageable member 90. Each of the aforementioned configurations protects the engageable member from the external environment. Alternatively, in some embodiments, the engageable member 90 is external to the sealed housing 40. This configuration may provide easy access for maintenance, for example.

The engageable member is operably coupled to an actuator 97 via one or more shafts 94. The shaft(s) 94 may be flexible or rigid. The actuator is operated manually via a user in order to rotate the shaft(s) 94, which rotates the engageable member 90, which rotates the intermediate gear 92, which rotates the gear 60 about its axis 16.

In some embodiments, the engageable member 90 is operably coupled to a motor that is operable via a button and/or control panel. The motor is configured rotate the engageable member using energy from the engine 22 or a battery (not shown).

FIG. 9 shows the actuator 97. The actuator 97 is operably coupled to the engageable member 90 via the shaft(s) 94. The engageable member 90 is operably coupled to the gear 60. Therefore, during normal use of the outboard motor, the actuator 97 rotates as the gear 60 rotates. Thus, in some embodiments, as shown in FIG. 8, the actuator 97 is covered via a cap 99.

During a failure of the normal steering system, the actuator 97 may be used to rotate the gear 60, thus steering the outboard motor. For example, if the members 30A, 30B become unresponsive or disengaged with the gear 60, the gear 60 may be locked in positon by the present of hydraulic fluid 44 within the cylinders 41A, 41B. In this scenario, the user is able to move the override valve 145 into the second position, thus allowing movement of hydraulic fluid between the cylinders 41A, 41B. The user can then manually rotate the actuator 97, thus rotating the gear 60. The override valve 145 may then be moved back to the first position, thus locking the gear 60 in its new position.

However, if sufficient hydraulic fluid is lost from the system, the gear 60 will be free to move. This, again, results in a steering failure as control over the member 30A, 30B is lost. In this scenario, movement of the override valve 145 between the first and second position is redundant. However, a user may still control the rotation of the gear 60 via the actuator 97.

In some embodiments, the outboard propulsion system comprises a lockable collar 98, as shown in FIGS. 9, 10A and 10B. When activated, the lockable collar 98 is configured to prevent movement of the second portion 50 relative to the first portion 20. Consequently, the lockable collar 98 enables a user to lock the steering direction of the outboard propulsion system when there is inadequate hydraulic fluid within the system. Consequently, the lockable collar 98 provides further redundancy within the system.

The lockable collar 98 is fixed to the transom of the boat. Moreover, the lockable collar 98 is configured to engage with the actuator 97 and prevent rotation thereof. More specifically, the lockable collar 98 is operable between a first and second position, wherein the first position allows rotation of the actuator 97 and the second position prevents rotation of the actuator 97.

FIG. 10A shows a section through the actuator 97 in the first position, wherein the lockable collar 98 is disengaged. In this position, the actuator 97 is free to rotate as the gear 60 rotates. Conversely, FIG. 10B shows a section through the actuator 97 in the second position, wherein when the lockable collar 98 is engaged, thus preventing rotation of the gear 60. More specifically, the lockable collar 98 comprises a plurality of protrusions 101. The actuator 97 also comprises a plurality of protrusions 102. The protrusion 101 on the lockable collar 98 are configured to engage and disengage with the protrusions 102 on the actuator 97, as shown in FIGS. 10A and 10B.

The shaft 94 comprises a threaded hole 104 at its distal end. The threaded hole 104 has a longitudinal axis 106. The actuator 97 is attached to the shaft 94 via a threaded bar 103 which is positioned within the threaded hole 104. In use, the actuator 97 may be rotated relative to the shaft 94 via a bolt 105, thus winding or unwinding the threaded bar 103 within the threaded hole 104 along the axis 106 of the hole. Accordingly, the actuator 97 may move along the axis 106 of the hole 104 relative to the lockable collar 98. At a certain point, the protrusions 102 of the actuator 97 engage with the protrusions 101 of the lockable collar 98. In this configuration, the actuator 97 is locked in place, thus preventing the shaft 94, engageable member 90 and gear 60 from rotating. The actuator may then be released by rotating a nut 105 in the opposing direction until the protrusions 102 of the actuator 97 disengage with the protrusions 101 of the lockable collar 98.

Alternatively, in some embodiments, not shown, the lockable collar may be a mechanical fastener. The lockable collar may be configured to engage with the actuator, shaft 94 and/or engageable member 90. Alternatively, or in addition, the lockable collar may be configured to engage with the second portion 50 directly.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless the context dictates otherwise, the descriptions and definitions of the features set out above are not limited to any particular aspect or embodiment of the invention and apply equally to all aspects and embodiments which are described.

It will further be appreciated by those skilled in the art that, although the invention has been described by way of example with reference to several embodiments, the invention is not limited to the disclosed embodiments and that alternative embodiments could be constructed without departing from the scope of the invention as defined in the appended claims.

1. An outboard propulsion system comprising:
a first portion for attachment to a boat, wherein the first portion is fixed about a substantially vertical axis, and
a second portion connected to the first portion and configured to rotate about a steering axis,
wherein the first portion comprises a sealed housing enclosing a member having a longitudinal axis relative to which it may move and the second portion comprises a gear configured to engage with the member such that movement of the member relative to its longitudinal axis generates rotational movement of the gear about the steering axis, and
wherein the sealed housing comprises a sensor configured to determine the position of the member within the sealed housing.

2. The outboard propulsion system according to claim 1, wherein the member comprises a magnet and wherein the sensor is configured to monitor the change in magnetic field produced by the magnet in order to determine the position of the member within the sealed housing.

3. The outboard propulsion system according to claim 1, wherein the first portion comprises an engine and a transmission assembly, and the second portion comprises a propeller shaft, and wherein the engine is configured to provide motive power to the propeller shaft via the transmission assembly.

4. The outboard propulsion system according to claim 1, wherein the gear is connected to the second portion such that rotation of the gear causes rotation of the second portion relative to the first portion.

5. The outboard propulsion system according to claim 1, wherein the steering axis is non-vertical.

6. The outboard propulsion system according to claim 1, wherein the member is operably connected to a motor configured to generate movement of the member relative to its longitudinal axis.

7. The outboard propulsion system according to claim 1, wherein the member moves along its longitudinal axis.

8. The outboard propulsion system according to claim 1, wherein the member moves around its longitudinal axis.

9. The outboard propulsion system according to claim 1, wherein the sealed housing comprises a cylinder having two chambers separated by the member and wherein each chamber is configured to receive a hydraulic fluid.

10. The outboard propulsion system according to claim 1, wherein the sealed housing encloses two members, each having a longitudinal axis relative to which it may move, and
wherein the gear is configured to engage with each member such that movement of at least one member relative to its longitudinal axis generates rotational movement of the gear about the steering axis.

11. The outboard propulsion system according to claim 10, wherein the first and second members are positioned such that rotational movement of the gear causes movement of the first member in a first direction and movement of the second member in a second direction.

12. The outboard propulsion system according to claim 11, wherein the first direction is the opposite direction to the second direction.

13. The outboard propulsion system according to claim 1, further comprising a conduit providing fluid communication between the first and second portion, wherein the conduit passes from the first portion directly into the second portion.

14. The outboard propulsion system according to claim 12, wherein the conduit between the first and second portion is substantially linear.

15. The outboard propulsion system according to claim 13, wherein the conduit passes through an aperture in the gear.

16. The outboard propulsion system according to claim 13, further comprising a drive shaft configured to transfer motive power between the first and second portion, wherein a portion of the drive shaft is located within the conduit.

17. The outboard propulsion system according to claim 16, further comprising a sleeve located within the conduit and configured to enclose a portion of the drive shaft.

18. The outboard propulsion system according to claim 13, wherein the conduit is a first conduit and further comprising a second conduit configured to enclose the first conduit and provide fluid communication between the first and second portion.

19. The outboard propulsion system according to claim 18, wherein the first conduit is configured to receive water and the second conduit is configured to receive exhaust gas.

20. The outboard propulsion system according to claim 1, wherein the first portion comprises an engageable component having an axis relative to which it may move, and wherein the engageable component is operably engaged with the gear such that movement of the engageable component relative to its axis generates rotational movement of the gear about the steering axis.
